(19) United States
(12) Patent Application Publication
(10) Pub. No.: US 2014/0192009 A1
(43) Pub. Date: Jul. 10, 2014

(54) TOUCH PANEL

(71) Applicant: Novatek Microelectronics Corp., Hsinchu (TW)

(72) Inventors: Chih-Chang LAI, Taichung City (TW); Ta-Keng WENG, Taichung City (TW)

(21) Appl. No.: 13/930,755

(22) Filed: Jun. 28, 2013

(30) Foreign Application Priority Data
Jan. 7, 2013 (TW) 102100371

(51) Int. Cl. G06F 3/044

(52) U.S. Cl. CPC G06F 3/044
USPC 345/174

(57) ABSTRACT

A touch panel comprising a substrate, a plurality of first sensing electrodes, a plurality of second sensing electrodes, an insulating layer and a cover lens is provided. The first sensing electrodes are disposed on the substrate and are arranged in a first direction. The second sensing electrodes are disposed on the substrate and are arranged in a second direction. The first direction and the second directions are different. The insulating layer is disposed between the first and the second sensing electrodes. The cover lens is disposed on the insulating layer and has a non-uniform thickness. At least one of the surface areas of the first and the second sensing electrodes is related to the non-uniform thickness of the cover lens.

This application claims the benefit of Taiwan application Serial No. 102100371, filed Jan. 7, 2013, the subject matter of which is incorporated herein by reference.

### BACKGROUND OF THE INVENTION

1. Field of the Invention

The invention relates in general to a touch panel and more particularly to a touch panel in which the area of the sensing electrodes varies with the thickness of the cover lens.

2. Description of the Related Art

Touch panels, which allow the user to intuitively and conveniently operate by way of touch control, are deeply loved by consumers and have become more and more popular in the market of electronic products.

Basically, there are two types of touch panels: the resistive touch panels and the capacitive touch panels. The principles of operation for the two types of touch panels are not the same. The resistive touch panel comprises a glass panel, a conductive layer and a resistive metal layer. When the user touches the panel, the conductive layer will come into contact with the resistive metal layer, and the amount of current and the magnitude of the electric field are changed accordingly. The change in the current and electric field is viewed as a touch event, and a signal is transmitted to the controller for processing.

The capacitive touch panel uses a capacitive sensor to detect a touch event. When the user touches the screen, a continuous flow of current will flow through the sensor, such that the sensor can precisely store electrons in both a vertical direction and a horizontal direction to form a capacitance field with precision control. When a finger touches another position, the capacitance field of the sensor is changed by another capacitance field. Meanwhile, the circuit at each corner of the panel calculates the change of the electric field, and then transmits the touch event signal to the controller for processing.

As the consumers have higher and higher requirement of the quality of the touch panel, the sensitivity and precision of sensing the touch also need to be improved to satisfy the market demand.

### SUMMARY OF THE INVENTION

The invention is directed to a touch panel. The area of the sensing electrodes of the touch panel is related to the thickness of the cover lens and can compensate the sensing capacitance difference which arises due to the non-uniform thickness of the cover lens.

According to an embodiment of the present invention, a touch panel comprising a substrate, a plurality of first sensing electrodes, a plurality of second sensing electrodes, an insulating layer and a cover lens is provided. The first sensing electrodes are disposed on the substrate and are arranged in a first direction. The second sensing electrodes are disposed on the substrate and are arranged in a second direction. The first direction and the second directions are different. The insulating layer is disposed between the first and the second sensing electrodes. The cover lens is disposed on the insulating layer and has a non-uniform thickness. At least one of the surface areas of the first and the second sensing electrodes is related to the non-uniform thickness of the cover lens.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A shows a partial cross-sectional view of a touch panel according to an embodiment of the invention;

FIG. 1B shows a top view of a touch panel according to an embodiment of the invention;

FIG. 2A shows a partial cross-sectional view of a touch panel according to another embodiment of the invention;

FIG. 2B shows another partial cross-sectional view of a touch panel according to another embodiment of the invention;

FIG. 2C shows another partial cross-sectional view of a touch panel according to another embodiment of the invention;

FIG. 2D shows a top view of a touch panel according to another embodiment of the invention;

FIG. 3A shows a partial cross-sectional view of a touch panel according to an alternate embodiment.

FIG. 3B shows a partial cross-sectional view of a touch panel according to an alternate embodiment;

FIG. 3C shows a partial cross-sectional view of a touch panel according to an alternate embodiment.

FIG. 3D shows a top view of a touch panel according to an alternate embodiment.

FIG. 4A shows a partial cross-sectional view of a touch panel according to an alternate embodiment of the invention;

FIG. 4B shows according to an embodiment of the invention a top view of a touch panel.

FIG. 5A shows a partial cross-sectional view of a touch panel according to an alternate embodiment of the invention; and

FIG. 5B shows a top view of a touch panel according to an alternate embodiment of the invention.

### DETAILED DESCRIPTION OF THE INVENTION

### First Embodiment

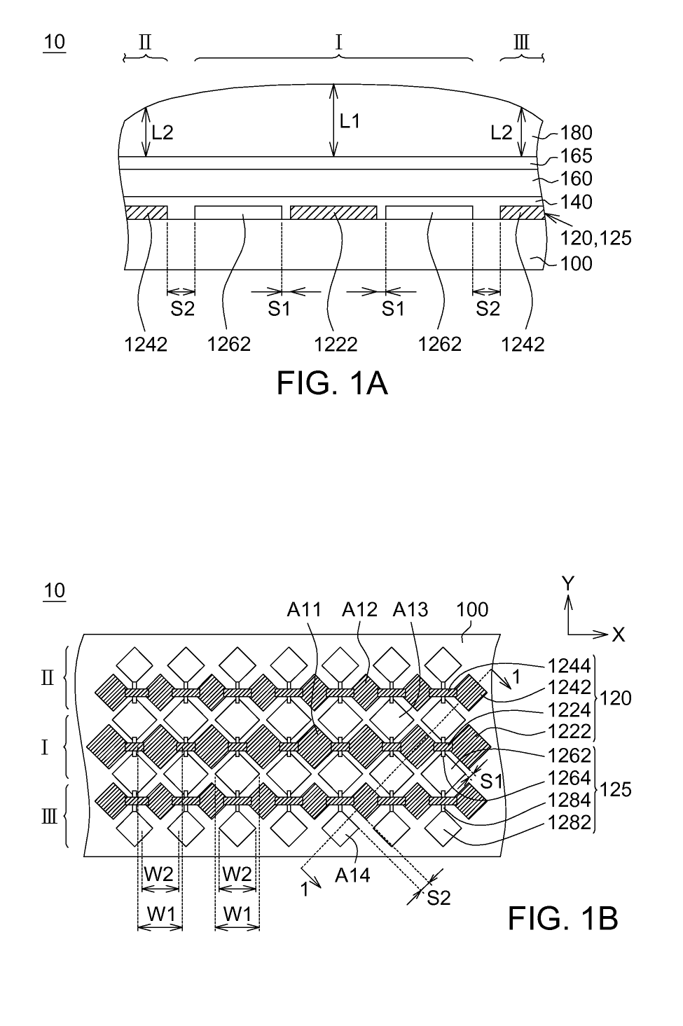

FIG. 1A shows a partial cross-sectional view of a touch panel 10 according to an embodiment of the invention. Referring to FIG. 1A, the touch panel 10 comprises a substrate 100, a plurality of first sensing electrodes 120, a plurality of second sensing electrodes 125, an insulating layer 140, a protection layer 160, an adhesive layer 165 and a cover lens 180. The first sensing electrodes 120 and the second sensing electrodes 125 are staggered with each other and are disposed on the substrate 100. The insulating layer 140 is disposed between the first sensing electrodes 120 and the second sensing electrodes 125. The protection layer 160 is disposed on the insulating layer 140. The adhesive layer 165 is used for fixing the protection layer 160 and the cover lens 180. The cover lens 180 is disposed on the insulating layer 140.

The cover lens 180 is such as an anti-scratch layer covering the top of each layer for protection purpose. In the present embodiment, the cover lens 180 has a non-uniform thickness, and has a first region I, a second region II and a third region III. The first region I has a first thickness L1, each of the second region II and the third region III has a second thickness L2, and the first thickness L1 is larger than the second thickness L2.

FIG. 1B shows a top view of a touch panel 10 according to an embodiment of the invention. The partial cross-sectional view of the touch panel 10 of FIG. 1A is a cross-section viewed along a cross-sectional line 1-1 of FIG. 1B. In FIG. 1B, only the substrate 100, the first sensing electrodes 120 and the second sensing electrodes 125 of the touch panel 10 are illustrated for convenience of describing the arrangement of the first sensing electrodes 120 and the second sensing electrodes 125. Referring to FIG. 1B, the first sensing electrodes 120 are disposed on the substrate 100 and are arranged in a first direction X. The second sensing electrodes 125 are disposed on the substrate 100 and are arranged in a second direction Y.

The first sensing electrodes 120 may comprise a plurality of first sub-electrodes 1222, a plurality of first wires 1224, a plurality of second sub-electrodes 1242 and a plurality of second wires 1244. The first wires 1224 are for electrically connecting their adjacent first sub-electrodes 1222. The second wires 1244 are for electrically connecting their adjacent second sub-electrodes 1242. The second sensing electrodes 125 may comprise a plurality of third sub-electrodes 1262, a plurality of third wires 1264, a plurality of fourth sub-electrodes 1282 and a plurality of fourth wires 1284. The third wires 1264 are for electrically connecting their adjacent third sub-electrodes 1262. The fourth wires 1284 are for electrically connecting their adjacent fourth sub-electrodes 1282. The first sub-electrodes 1222, the second sub-electrodes 1242, the third sub-electrodes 1262 and the fourth sub-electrodes 1282 are rhombic.

In an embodiment, each of the first sub-electrodes 1222 and the third sub-electrodes 1262 has a diagonal width W1, each of the second sub-electrodes 1242 and the fourth sub-electrodes 1282 has a diagonal width W2, and the width W1 is larger than the width W2. Therefore, the surface area All of the first sub-electrodes 1222 is larger than the surface area A12 of the second sub-electrodes 1242, and the surface area A13 of the third sub-electrodes 1262 is larger than the surface area A14 of the fourth sub-electrodes 1282. The first sub-electrodes 1222, the second sub-electrodes 1242, the third sub-electrodes 1262, the fourth sub-electrodes 1282 are transparent electrodes.

Referring to FIGS. 1A and 1B at the same time. The surface areas of the first sensing electrodes 120 and the second sensing electrodes 125 are related to the non-uniform thickness of the cover lens 180. For example, the cover lens comprises a first region I, a second region II and a third region III, wherein the first region I has a thickness L1, each of the second region II and the third region III has a thickness L2, and the thickness L1 is larger than the thickness L2. In the present embodiment, the cover lens 180 along the Y axis is an arced cover lens being thicker in the middle region and thinner in the remaining regions. That is, the first region I is located between the second region II and the third region III. In other embodiments, the cover lens 180 can have a wavy shape or other shapes, and the relative positions between the first region I, the second region II and the third region III of the cover lens 180 are not subjected to any specific restrictions.

As indicated in FIG. 1 B, the first region I of the cover lens covers the first sub-electrodes 1222 and the third sub-electrodes 1262, and the second region II and the third region III of the cover lens cover the second sub-electrodes 1242 and the fourth sub-electrodes 1282. A spacing S1 is formed between the first sub-electrodes 1222 and the third sub-electrodes 1262 covered by the first region I of the cover lens, a spacing S2 is formed between the second sub-electrodes 1242 and the fourth sub-electrodes 1282 covered by the third region III of the cover lens, and the spacing S1 is smaller than the spacing S2.

### Second Embodiment

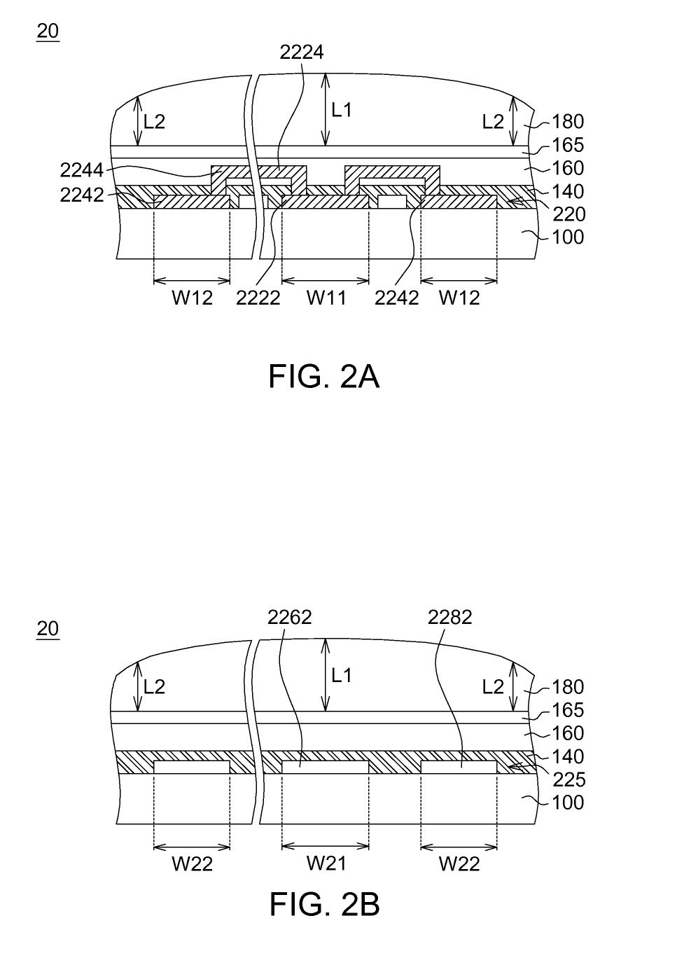

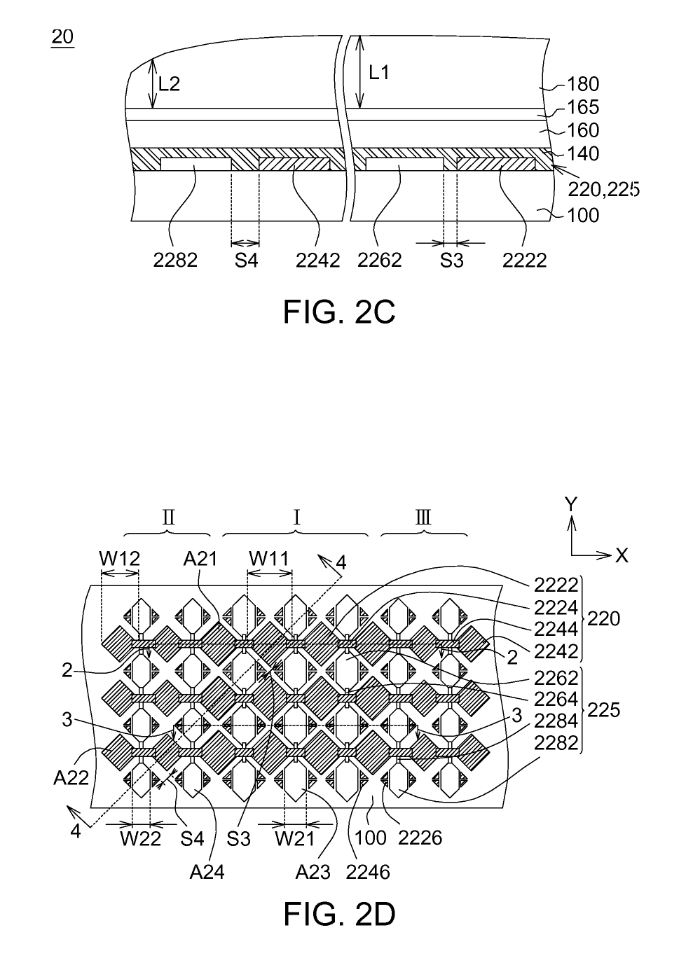

FIG. 2A shows a partial cross-sectional view of a touch panel 20 according to another embodiment of the invention. Referring to FIG. 2A, the touch panel 20 comprises a substrate 100, a plurality of first sensing electrodes 220, an insulating layer 140, a protection layer 160, an adhesive layer 165 and a cover lens 180. Since the touch panel 20 of FIG. 2A is cut along a direction of the first sensing electrodes 220, only the cross-section of the first sensing electrodes 220 is illustrated. The touch panel 20 is similar to the touch panel 10 of FIG. 1A. Common reference numerals are used throughout the drawings and the detailed description to indicate the same elements, and the similarities are not repeated here.

As indicated in FIG. 2A, the first wires 2224 are for electrically connecting their adjacent first sub-electrodes 2222, and the second wires 2244 are for electrically connecting their adjacent second sub-electrodes 2242. Each first sub-electrode 2222 has a width W11, each second sub-electrode 2242 has a width W12, and the width W11 is larger than the width W12. In other words, the sizes of the first sub-electrodes 2222 and the second sub-electrodes 2242 are related to the non-uniform thickness of the cover lens 180. For example, the cover lens 180 comprises a first region I, a second region II and a third region III (illustrated in FIG. 2D). The first region I has a thickness L1, each of the second region II and the third region III has a thickness L2, and the thickness L1 is larger than the thickness L2.

FIG. 2B shows another partial cross-sectional view of a touch panel 20 according to another embodiment of the invention. Since the touch panel 20 of FIG. 2B is cut along a direction of the second sensing electrodes 225, only a cross-section of the second sensing electrodes 225 is illustrated. In fact, the first sensing electrodes 220 (illustrated in FIG. 2D) and the second sensing electrodes 225 are staggered with each other and are disposed on the substrate 100. The touch panel 20 is similar to the touch panel 10 of FIG. 1A. Common reference numerals are used throughout the drawings and the detailed description to indicate the same elements and the similarities are not repeated here.

As indicated in FIG. 2B, each third sub-electrode 2262 has a width W21, each fourth sub-electrode 2282 has a width W22, and the width W21 is larger than the width W22. In other words, the sizes of the third sub-electrodes 2262 and the fourth sub-electrodes 2282 are related to the non-uniform thickness of the cover lens 180.

FIG. 2C shows another partial cross-sectional view of a touch panel 20 according to another embodiment of the invention. Since the touch panel 20 of FIG. 2C is cut along a staggering direction of the first sensing electrodes 220 and the second sensing electrodes 225, partial cross-sections of both the first sensing electrodes 220 and the second sensing electrodes 225 are illustrated. The touch panel 20 is similar to the touch panel 10 of FIG. 1A. Common reference numerals are used throughout the drawings and the detailed description to indicate the same elements and the similarities are not repeated here.

As indicated in FIG. 2C, a spacing S3 is formed between the first sub-electrodes 2222 and the third sub-electrodes 2262, a spacing S4 is formed between the second sub-electrodes 2242 and the fourth sub-electrodes 2282, and the spacing S4 is larger than the spacing S3. In other words, the spacings between the first sub-electrodes 2222, the second sub-electrodes 2242, the third sub-electrodes 2262 and the fourth sub-electrodes 2282 are related to the non-uniform thickness of the cover lens 180.

FIG. 2D shows a top view of a touch panel 20 according to another embodiment of the invention. Referring to FIGS. 2A-2D at the same time. The partial cross-sectional view of the touch panel 20 of FIG. 2A is a cross-section viewed along a cross-sectional line 2-2 of FIG. 2D. The partial cross-sectional view of the touch panel 20 of FIG. 2B is a cross-section viewed along a cross-sectional line 3-3 of FIG. 2D. The partial cross-sectional view of the touch panel 20 of FIG. 2C is a cross-section viewed along a cross-sectional line 4-4 of FIG. 2D, and only the substrate 100, the first sensing electrodes 220 and the second sensing electrodes 225 of the touch panel 20 are illustrated for the convenience of description.

Referring to FIG. 2D, the first sensing electrodes 220 are disposed on the substrate 100 and are arranged in a first direction X. The second sensing electrodes 225 are disposed on the substrate 100 and are arranged in a second direction Y. The touch panel 20 is similar to the touch panel 10 of FIG. 1B and the difference between the two touch panels lies in the shape and disposition of the first sensing electrodes 220 and the second sensing electrodes 225. In the present embodiment, the cover lens 180 along the X axis is an arced cover lens being thicker in the middle region and thinner in the remaining regions, and the first region I is located between the second region II and the third region III. In other embodiments, the cover lens 180 can have a wavy shape or other shapes, and the relative positions between the first region I, the second region II and the third region III of the cover lens 180 are not subjected to any specific restrictions.

The first sensing electrodes 220 may comprise a plurality of first sub-electrodes 2222, a plurality of first wires 2224, a plurality of second sub-electrodes 2242 and a plurality of second wires 2244. The first wires 2224 are for electrically connecting their adjacent first sub-electrodes 2222. The second wires 2244 are for electrically connecting their adjacent second sub-electrodes 2242. The second sensing electrodes 225 may comprise a plurality of third sub-electrodes 2262, a plurality of third wires 2264, a plurality of fourth sub-electrodes 2282 and a plurality of fourth wires 2284. The third wires 2264 are for electrically connecting their adjacent third sub-electrodes 2262. The fourth wires 2284 are for electrically connecting their adjacent fourth sub-electrodes 2282.

The first sub-electrodes 2222 and the second sub-electrodes 2242 are rhombic. The third sub-electrodes 2262 and the fourth sub-electrodes 2282 are hexagonal. Four triangular electrodes 2226 and 2246 can be symmetrically disposed on the peripheral of each of the third sub-electrodes 2262 and the fourth sub-electrodes 2282. In another embodiment, the disposition of the triangular electrodes 2226 and 2246 can be omitted, and the invention is not limited thereto.

Referring to FIG. 2A-2D at the same time. The surface areas of the first sensing electrodes 220 and the second sensing electrodes 225 are related to the non-uniform thickness of the cover lens 180. For example, the first region I of the cover lens 180 has a thickness L1, each of the second region II and the third region III of the cover lens 180 has a thickness L2, and the thickness L1 is larger than the thickness L2. Each first sub-electrode 2222 has a diagonal width W11, each second sub-electrode 2242 has a diagonal width W12, each third sub-electrode 2262 has a width W21, and each fourth sub-electrode 2282 has a width W22, wherein the width W11 is larger than the width W12, and the width W21 is larger than the width W22.

In the present embodiment, the surface area of A21 of the first sub-electrodes 2222 is larger than the surface area A22 of the second sub-electrodes 2242, and the surface area A23 of the third sub-electrodes 2262 is larger than the surface area A24 of the fourth sub-electrodes 2282. The first sub-electrodes 2222, the second sub-electrodes 2242, the third sub-electrodes 2262, the fourth sub-electrodes 2282 are transparent electrodes. In the present embodiment, the cover lens 180 is an arced cover lens being thicker in the middle region and thinner in the remaining regions, and the first region I is located between the second region II and the third region III. In other embodiments, the cover lens 180 can have a wavy shape or other shapes, and the relative positions between the first region I, the second region II and the third region III of the cover lens 180 are not subjected to any specific restrictions.

As indicated in FIG. 2D, the first region I of the cover lens 180 covers the first sub-electrodes 2222 and the third sub-electrodes 2262, and the second region II and the third region III of the cover lens 180 cover the second sub-electrodes 2242 and the fourth sub-electrodes 2282. A spacing S3 is formed between the first sub-electrodes 2222 and the third sub-electrodes 2262 covered by the first region I of the cover lens 180, a spacing S4 is formed between the second sub-electrodes 2242 and the fourth sub-electrodes 2282 covered by the second region II and the third region III of the cover lens 180, and the spacing S3 is smaller than the spacing S4.

### Third Embodiment

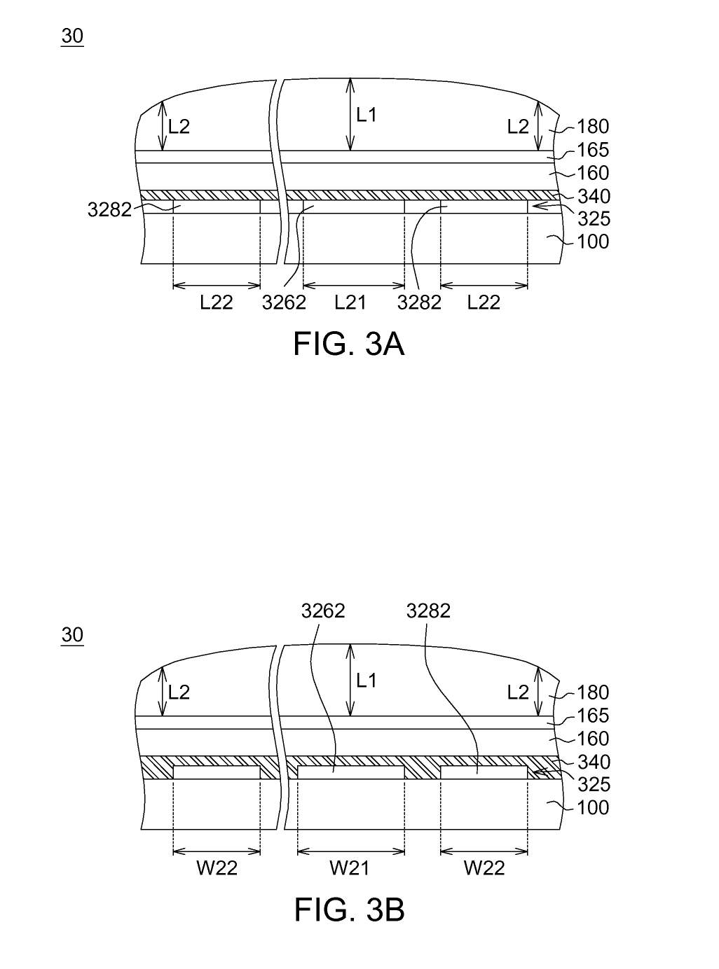

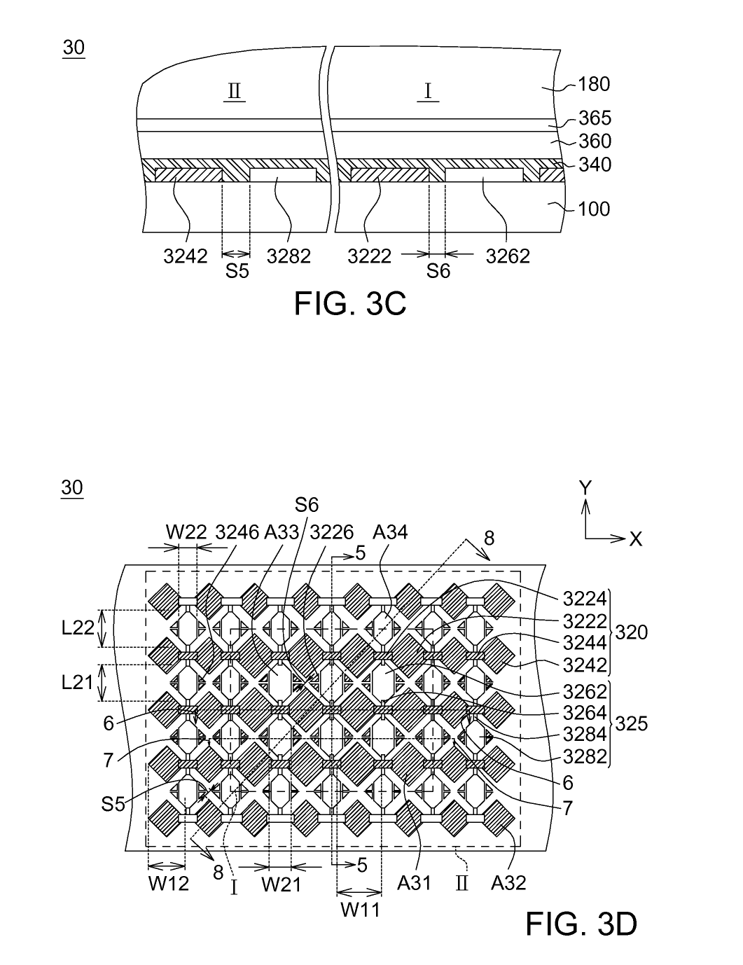

FIG. 3A shows a partial cross-sectional view of a touch panel 30 according to an alternate embodiment. Referring to FIG. 3A, the touch panel 30 comprises a substrate 100, a plurality of first sensing electrodes 320 (illustrated in FIG. 3D), a plurality of second sensing electrodes 325, an insulating layer 340, a protection layer 160, an adhesive layer 165 and a cover lens 180. In the present embodiment, the first sensing electrodes 320 and the second sensing electrodes 325 are staggered with each other and are disposed on the substrate 100. Since the touch panel 30 of FIG. 3A is cut along a direction parallel to the second sensing electrodes 325, only partial cross-section of the second sensing electrodes 325 is illustrated, and partial structure is omitted.

As indicated in FIG. 3A, each third sub-electrode 3262 has a length L21, each fourth sub-electrode 3282 has a length L22, and the length L21 is larger than the length L22. The sizes of the third sub-electrodes 3262 and the fourth sub-electrodes 3282 are related to the non-uniform thickness of the cover lens 180. For example, the cover lens 180 comprises a first region I and a second region II (illustrated in FIG. 3D), wherein the first region I has a thickness L1, the second region II has a thickness L2, and the thickness L1 is larger than the thickness L2. In the present embodiment, the cover lens 180 along the X-Y plane is an arced cover lens being thicker in the middle region and thinner in the remaining regions. That is, the first region I is located in the middle of the second region II and surrounded by the second region II. In other embodiments, the cover lens 180 can have a wavy shape or other shapes, and the relative positions between the first region I, the second region II and the third region III of the cover lens 180 are not subjected to any specific restrictions.

FIG. 3B shows a partial cross-sectional view of a touch panel 30 according to an alternate embodiment. Since the touch panel 30 of FIG. 3B is cut along a direction perpendicular to the second sensing electrodes 325, only partial cross-section of the second sensing electrodes 325 is illustrated, and partial structure is omitted. The touch panel 30 is similar to the touch panel 10 of FIG. 1A. Common reference numerals are used throughout the drawings and the detailed description to indicate the same elements and the similarities are not repeated here. In the present embodiment, each third sub-electrode 3262 has a width W21, each fourth sub-electrode 3282 has a width W22, and the width W21 is larger than the width W22. In other words, the sizes of the third sub-electrodes 3262 and the fourth sub-electrodes 3282 are related to the non-uniform thickness of the cover lens 180.

FIG. 3C shows a partial cross-sectional view of a touch panel 30 according to an alternate embodiment. Since the touch panel 30 of FIG. 3C is cut along a staggering direction of the first sensing electrodes 320 and the second sensing electrodes 325 of the touch panel 30, and partial cross-sections of both the first sensing electrodes 320 and the second sensing electrodes 325 are illustrated. The touch panel 30 is similar to the touch panel 10 of FIG. 1A. Common reference numerals are used throughout the drawings and the detailed description to indicate the same elements and the similarities are not repeated here.

As indicated in FIG. 3C, a spacing S5 is formed between the second sub-electrodes 3242 and the fourth sub-electrodes 3282, a spacing S6 is formed between the first sub-electrodes 3222 and the third sub-electrodes 3262, and the spacing S5 is larger than the spacing S6. In other words, the spacing between the first sub-electrodes 3222, the second sub-electrodes 3242, the third sub-electrodes 3262 and the fourth sub-electrodes 3282 is related to the non-uniform thickness of the cover lens 180.

FIG. 3D shows a top view of a touch panel 30 according to an alternate embodiment. Referring to FIGS. 3A-3D at the same time. The partial cross-sectional view of the touch panel 30 of FIG. 3A is a cross-section viewed along a cross-sectional line 5-5 of FIG. 3D. The structure of the cross-section cut along a cross-sectional line 6-6 of FIG. 3D is similar to FIG. 2A, and the similarities are not repeated here. The partial cross-sectional view of the touch panel 30 of FIG. 3B is such as a structure of the cross-section cut along a cross-sectional line 7-7 of FIG. 3D. The partial cross-sectional view of the touch panel 30 of FIG. 3C is a cross-section viewed along a cross-sectional line 8-8 of FIG. 3D, and only the substrate 100, the first sensing electrodes 320 and the second sensing electrodes 325 of the touch panel 30 are illustrated for the convenience of description.

The touch panel 30 is similar to the touch panel 20 of FIG. 2C. Common reference numerals are used throughout the drawings and the detailed description to indicate the same elements. Similarities are not repeated and the difference between the two touch panels lies in the disposition of the first sensing electrodes 320 and the second sensing electrodes 325. Referring to FIG. 3D, the first sensing electrodes 320 are disposed on the substrate 100 and are arranged in a first direction X. The second sensing electrodes 325 are disposed on the substrate 100 and are arranged in a second direction Y.

The first sensing electrodes 320 may comprise a plurality of first sub-electrodes 3222, a plurality of first wires 3224, a plurality of second sub-electrodes 3242 and a plurality of second wires 3244. The first wires 3224 are for electrically connecting their adjacent first sub-electrodes 3222. The second wires 3244 are for electrically connecting their adjacent second sub-electrodes 3242. The second sensing electrodes 325 may comprise a plurality of third sub-electrodes 3262, a plurality of third wires 3264, a plurality of fourth sub-electrodes 3282 and a plurality of fourth wires 3284. The third wires 3264 are for electrically connecting their adjacent third sub-electrodes 3262. The fourth wires 3284 are for electrically connecting their adjacent fourth sub-electrodes 3282.

The first sub-electrodes 3222 and the second sub-electrodes 3242 are rhombic. The third sub-electrodes 3262 and the fourth sub-electrodes 3282 are hexagonal. Four triangular electrodes 3226 and 3246 can be symmetrically disposed on the peripheral of each of the third sub-electrodes 3262 and the fourth sub-electrodes 3282. In an embodiment, the disposition of the triangular electrodes 3226 and 3246 can be omitted, and the invention is not limited thereto. As indicated in FIG. 3D, each first sub-electrode 3222 has a diagonal width W11, each second sub-electrode 3242 has a diagonal width W12, each third sub-electrode 3262 has a width W21, and each fourth sub-electrode 3282 has a width W22, wherein the width W11 is larger than the width W12, and the width W21 is larger than the width W22. The surface area A31 of the first sub-electrodes 3222 is larger than the surface area A32 of the second sub-electrodes 3242, and the surface area A33 of the third sub-electrodes 3262 is larger than the surface area A34 of the fourth sub-electrodes 3282. The first sub-electrodes 3222, the second sub-electrodes 3242, the third sub-electrodes 3262, and the fourth sub-electrodes 3282 are transparent electrodes.

Referring to FIGS. 3A-3D at the same time. The surface areas of the first sensing electrodes 320 and the second sensing electrodes 325 are related to the non-uniform thickness of the cover lens 180. For example, the cover lens may comprise a first region I and a second region II, wherein the first region I has a thickness L1, the second region II has a thickness L2, and the thickness L1 is larger than the thickness L2. The first region of the cover lens I covers the first sub-electrodes 3222 and the third sub-electrodes 3262, and the second region of the cover lens II covers the second sub-electrodes 3242 and the fourth sub-electrodes 3282.

In the present embodiment, the cover lens 180 is an arced cover lens being thicker in the middle region and thinner in the remaining regions. The second region II surrounds the first region I. In other embodiments, the cover lens 180 can have a wavy shape or other shapes, and the relative positions between the first region I, the second region II and the third region III of the cover lens 180 are not subjected to any specific restrictions as long as the surface areas of the first sensing electrodes 320 and the second sensing electrodes 325 vary with the non-uniform thickness of the cover lens 180.

### Fourth Embodiment

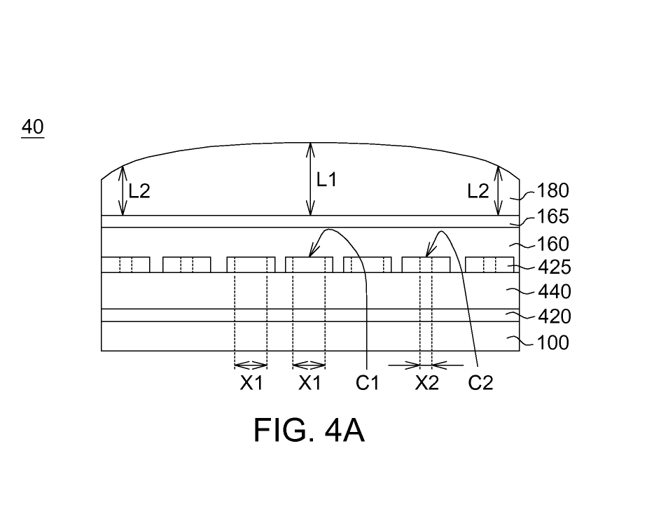

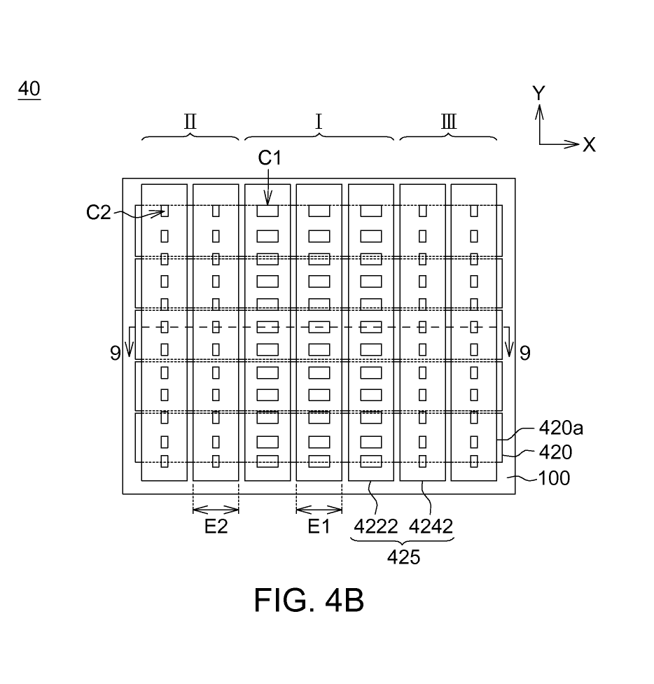

FIG. 4A shows a partial cross-sectional view of a touch panel 40 according to an alternate embodiment of the invention. Referring to FIG. 4A, the touch panel 40 comprises a substrate 100, a plurality of first sensing electrodes 425, a plurality of second sensing electrodes 420, an insulating layer 440, a protection layer 160, an adhesive layer 165 and a cover lens 180. The second sensing electrodes 420 are disposed on the substrate 100. The insulating layer 440 is disposed on the second sensing electrodes 420. The first sensing electrodes 425 are disposed on the insulating layer 440. The protection layer 160 is disposed on the first sensing electrodes 425. The protection layer 160, the adhesive layer 165 and the cover lens 180 can be similar to that of the above embodiments, and the similarities are not repeated here.

FIG. 4B shows a top view of a touch panel 40 according to an embodiment of the invention. The partial cross-sectional view of the touch panel 40 of FIG. 4A is a cross-section viewed along a cross-sectional line 9-9 of FIG. 4B, and only the substrate 100, the first sensing electrodes 425 and the second sensing electrodes 420 of the touch panel 40 are illustrated for the convenience of description. Referring to FIG. 4B, the first sensing electrodes 425 and the second sensing electrodes 420 of the touch panel 40 have a strip shape and are such as rectangular or bar-type sensing electrodes. The first sensing electrodes 425 are disposed on the substrate 100 and are arranged in a second direction Y. The second sensing electrodes 420 are disposed on the substrate 100 and are arranged in a first direction X. The distances from two adjacent first sensing electrodes 425 to the central axis are the same, and the distances from two adjacent second sensing electrodes 420 to the central axis are also the same.

As indicated in FIG. 4B, the first sensing electrodes 425 and the second sensing electrodes 420 have a strip shape and are such as rectangular or bar-type sensing electrodes. The first sensing electrodes 425 and the second sensing electrodes 420 can also have other strip shapes, and the invention is not limited thereto. The first sensing electrodes 425 may comprise a plurality of first sub-electrodes 4222 and a plurality of second sub-electrodes 4242. In an embodiment, each first sub-electrode 4222 has an opening C1, and each second sub-electrode 4242 has an opening C2, wherein the opening Cl has a width X1, and the opening C2 has a width X2. When the first sub-electrodes 4222 and the second sub-electrodes 4242 have the same length and the same width, the width El of the first sub-electrode 4222 is equal to the width E2 of the second sub-electrode 4242, and the surface area of the first sub-electrodes 4222 is smaller than that of the second sub-electrodes 4242.

Referring to FIG. 4A and 4B at the same time. The surface area of the first sensing electrodes 425 is related to the non-uniform thickness of the cover lens 180. For example, the cover lens may comprise a first region I, a second region II and a third region III, wherein the first region I has a thickness L1, each the second region II and the third region III has a thickness L2, and the thickness L1 is larger than the thickness L2. The first region of the cover lens I covers the first sub-electrodes 4222, the second region II and the third region III of the cover lens cover the second sub-electrodes 4242. In the present embodiment, the first sensing electrodes 425 are compensated according to the non-uniform thickness of the cover lens 180. In another embodiment, the second sensing electrodes 420 can also be compensated according to the non-uniform thickness of the cover lens 180.

In the present embodiment, the first region I of the cover lens 180 is thicker and mainly covers the first sub-electrodes 4222 of the first sensing electrodes 425, and the first sub-electrodes 4222 have a larger opening C1. Therefore, more fringe sensing capacitance can be generated between the first sub-electrodes 4222 and the second sensing electrodes 420, and the reduction in the sensing capacitance which arises due to the thicker cover lens 180 can thus be compensated.

### Fifth Embodiment

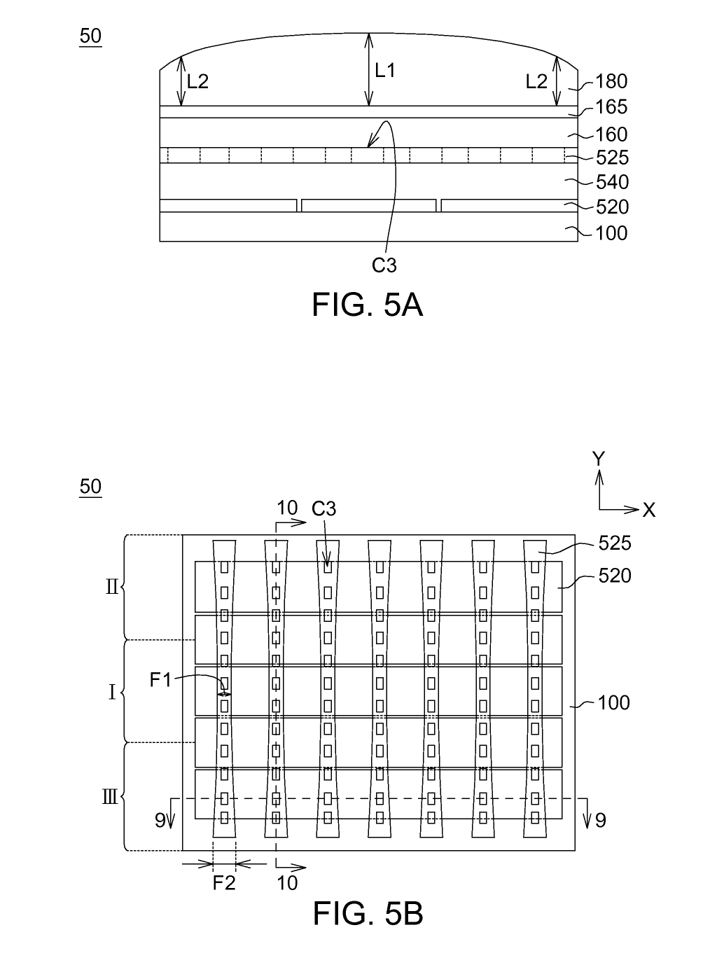

FIG. 5A shows a partial cross-sectional view of a touch panel 50 according to an alternate embodiment of the invention. Referring to FIG. 5A, the touch panel 50 comprises a substrate 100, a plurality of first sensing electrodes 525, a plurality of second sensing electrodes 520, an insulating layer 540, a protection layer 160, an adhesive layer 165 and a cover lens 180. The second sensing electrodes 520 are disposed on the substrate 100. The insulating layer 540 is disposed on the second sensing electrodes 520. The first sensing electrodes 525 are disposed on the insulating layer 540. The protection layer 160 is disposed on the first sensing electrodes 525. The protection layer 160, the adhesive layer 165 and the cover lens 180 can be the same or similar with the above embodiments, and the similarities are not repeated here.

FIG. 5B shows a top view of a touch panel 50 according to an alternate embodiment of the invention. The partial cross-sectional view of the touch panel 50 of FIG. 5A is a cross-section viewed along a cross-sectional line 10-10 of FIG. 5B, and only the substrate 100, the first sensing electrodes 525 and the second sensing electrodes 520 of the touch panel 50 are illustrated for the convenience of description. Referring to FIG. 5B, the first sensing electrodes 525 of the touch panel 50 have a strip shape and are arranged in a second direction Y and are disposed on the substrate 100. The second sensing electrodes 520 are arranged in a first direction X and are disposed on the substrate 100.

As indicated in FIG. 5B, the first sensing electrodes 525 are strip-shaped transparent electrodes having arced edges, and the first sensing electrodes 525 has a plurality of openings C3. The sizes of the opening C3 can be the same.

Referring to FIG. 5A and 5B at the same time. The width of the first sensing electrodes 525 is non-uniform. In an embodiment, each first sensing electrode 525 at least has a width F1 and a width F2, wherein the width F1 is smaller than the width F2. The surface area of the first sensing electrodes 525 is related to the non-uniform thickness of the cover lens 180. For example, the first region I of the cover lens 180 has a thickness L1, each of the second region II and the third region III has a thickness L2, and the thickness L1 is larger than the thickness L2. The first region I of the cover lens 180 covers the first sensing electrodes 525 having a width F1. Each of the second region II and the third region III of the cover lens 180 covers the first sensing electrodes 525 having a width F2. In the present embodiment, the first sensing electrodes 525 are compensated according to the non-uniform thickness of the cover lens 180. In another embodiment, the second sensing electrodes 520 can be compensated according to the non-uniform thickness of the cover lens 180.

In the present embodiment, the first sensing electrodes 525 having a narrower width F1 is covered by the first region I of the cover lens 180 , and the first region I is thicker than other regions. Therefore, more sensing capacitance can be generated between the first sensing electrodes 525 and the second sensing electrodes 520, and the reduction in the sensing capacitance which arises due to the thicker cover lens 180 can thus be compensated.

To summarize, the areas of the sensing electrodes of the above embodiments of the invention vary with the thickness of the cover lens. In an embodiment, the thicker part of the cover lens can be compensated through a large area of sensing electrodes to increase the sensing capacitance. In another embodiment, the thicker part of the cover lens can be compensated through the openings formed by hollowing the sensing electrodes to increase the fringe sensing capacitance. In another embodiment, the sensing capacitance can be compensated through the spacing between the sub-electrodes of the sensing electrodes.

While the invention has been described by way of example and in terms of the preferred embodiment(s), it is to be understood that the invention is not limited thereto. On the contrary, it is intended to cover various modifications and similar arrangements and procedures and the scope of the appended claims therefore should be accorded the broadest interpretation so as to encompass all such modifications and similar arrangements and procedures.

What is claimed is:

1. A touch panel, comprising:
a substrate;
a plurality of first sensing electrodes disposed on the substrate and arranged in a first direction;
a plurality of second sensing electrodes disposed on the substrate and arranged in a second direction different from the second direction;
an insulating layer disposed between the first and the second sensing electrodes; and
a cover lens disposed on the insulating layer and having a non-uniform thickness, wherein at least one of a surface area of the first sensing electrodes and a surface area of the second sensing electrodes is related to the non-uniform thickness of the cover lens.

2. The touch panel according to claim 1, wherein the first sensing electrodes comprise a plurality of first sub-electrodes and a plurality of second sub-electrodes, and a surface area of the first sub-electrodes is larger than a surface area of the second sub-electrodes.

3. The touch panel according to claim 2, wherein the first sensing electrodes further comprise a plurality of first wires electrically connecting two adjacent ones of the first and the second sub-electrodes.

4. The touch panel according to claim 3, wherein the second sensing electrodes comprise a plurality of third sub-electrodes and a plurality of fourth sub-electrodes, and further comprise a plurality of second wires for electrically connecting two adjacent ones of the third and the fourth sub-electrodes.

5. The touch panel according to claim 2, wherein the cover lens at least comprises a first region having a first thickness and a second region having a second thickness, the first thickness is larger than the second thickness, the first region of the cover lens covers the first sub-electrodes, and the second region of the cover lens covers the second sub-electrodes.

6. The touch panel according to claim 2, wherein the cover lens at least comprises a first region having a first thickness and a second region having a second thickness, the first thickness is larger than the second thickness, a first spacing is formed between two adjacent first sub-electrodes covered by the first region of the cover lens, a second spacing is formed between two adjacent second sub-electrodes covered by the second region of the cover lens, and the first spacing is smaller than the second spacing.

7. The touch panel, wherein according to claim 6, the second sensing electrodes comprise a plurality of third sub-electrodes and a plurality of fourth sub-electrodes, a third spacing is formed between two adjacent third sub-electrodes covered by the first region of the cover lens, a fourth spacing is formed between two adjacent fourth sub-electrodes covered by the second region of the cover lens, and the third spacing is smaller than the fourth spacing.

8. The touch panel according to claim 1, wherein the first sensing electrodes comprise at least one first sub-electrode and at least one second sub-electrode, the at least one first sub-electrode has a plurality of first openings, the at least one second sub-electrode has a plurality of second openings, and a size of each first opening is larger than a size of each second opening.

9. The touch panel according to claim 8, wherein the cover lens at least comprises a first region having a first thickness and a second region having a second thickness, the first thickness is larger than the second thickness, the first region of the cover lens covers the at least one first sub-electrode, and the second region of the cover lens covers the at least one second sub-electrode.

10. The touch panel according to claim 8, wherein the first openings and/or the second openings are rectangular, circular or polygonal.

11. The touch panel according to claim 1, wherein the first and the second sensing electrodes are rectangular or rhombic.

12. The touch panel according to claim 1, wherein each first sensing electrode is a strip having an arced edge, and a width of each first sensing electrode is related to a curvature of the arced edge.

13. The touch panel according to claim 12, wherein the cover lens has a central region, the non-uniform thickness of the cover lens gradually decreases from the central region towards a second region, a part of each first sensing electrode corresponding to the central region of the cover lens has a first arc, another part of each first sensing electrode corresponding to the second region of the cover lens has a second arc, and a curvature of the first arc is smaller than a curvature of the second arc.

14. The touch panel according to claim 1, wherein each first sensing electrode is a strip whose width corresponds to the non-uniform thickness of the cover lens.

15. The touch panel according to claim 14, wherein the cover lens has a central region and a second region, the non-uniform thickness of the cover lens gradually decreases from the central region towards the second region, the strip has a first width and a second width, the first width is larger than the second width, the central region covers the second width of the strip, and the second region covers the first width of the strip.

16. The touch panel according to claim 1, wherein the cover lens has a central region and a second region, the non-uniform thickness of the cover lens gradually decreases from the central region towards the second region, and the surface area of each first sensing electrode gradually increases from the part corresponding to the central region towards the part corresponding to the second region.

17. The touch panel according to claim 16, wherein a spacing of the first sensing electrodes gradually increase from a part corresponding to the central region towards a part corresponding to the second region.

18. The touch panel according to claim 1, wherein the first sensing electrodes are rhombic or hexagonal, and the second sensing electrodes are rhombic or hexagonal.
